(19) United States
(12) Patent Application Publication
(10) Pub. No.: US 2023/0391364 A1
(43) Pub. Date: Dec. 7, 2023

(54) SYSTEMS AND METHODS FOR DETERMINISTIC SELECTION IN A PARALLELIZED ASYNCHRONOUS MULTI-OBJECTIVE OPTIMIZER FOR PLANNING TRAJECTORY OF AN AUTONOMOUS VEHICLE

(71) Applicant: GM CRUISE HOLDINGS LLC, SAN FRANCISCO, CA (US)

(72) Inventors: Sean Skwerer, San Francisco, CA (US); Sam Ling Zeng, Hayward, CA (US); Abhishek Jain, Alameda, CA (US); Nenad Uzunovic, San Carlos, CA (US)

(73) Assignee: GM CRUISE HOLDINGS LLC, SAN FRANCISCO, CA (US)

(21) Appl. No.: 17/830,927

(22) Filed: Jun. 2, 2022

(51) Int. Cl. B60W 60/00

(52) U.S. Cl. CPC B60W 60/0011

(57) ABSTRACT

For one embodiment of the present disclosure, a computer implemented method provides deterministic multi-objective constrained optimization for a planning system of an autonomous vehicle (AV). The computer implemented method comprises initializing a planning solver with a plurality of candidate trajectories for an autonomous vehicle, selecting two or more optimal candidate trajectories that potentially satisfy all constraints and evaluating these two or more optimal candidate trajectories in parallel asynchronously using cost functions, determining whether a cost threshold is violated for a node in a temporarily ordered sequence of nodes for a branch of each of the two or more optimal candidate trajectories, and intentionally stopping branch evaluation early for a branch having a cost threshold violation.

### TECHNICAL FIELD

Embodiments described herein generally relate to the fields of autonomous vehicles and driver assistance vehicles, and more particularly relate to systems and methods for deterministic selection in a parallelized asynchronous multi-objective optimizer for planning trajectory of an autonomous vehicle.

### BACKGROUND

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The vehicles can be used to pick up passengers and drive the passengers to selected destinations. The vehicles can also be used to pick up packages and/or other goods and deliver the packages and/or goods to selected destinations.

### SUMMARY

For some embodiments of the present disclosure, systems and methods for deterministic selection in a parallelized asynchronous multi-objective optimizer for planning trajectory of an autonomous vehicle are described. For some embodiments of the present disclosure, a computer implemented method comprises initializing a planning solver with a plurality of candidate trajectories for an autonomous vehicle, selecting two or more optimal candidate trajectories that potentially satisfy all constraints and evaluating these two or more optimal candidate trajectories in parallel asynchronously using tactics for cost functions, determining a node (e.g., a first node, an initial node), in a temporarily ordered sequence of nodes, for which a cost threshold is violated, if any, for a branch of each of the two or more optimal candidate trajectories, and intentionally stopping branch evaluation early for a branch having a cost threshold violation. In one example of an embodiment, a branch and an optimal candidate trajectory have a one-to-one correspondence.

Other features and advantages of embodiments of the present disclosure will be apparent from the accompanying drawings and from the detailed description that follows below.

### BRIEF DESCRIPTION OF THE DRAWINGS

FIG. 1 illustrates an autonomous vehicle and remote computing system architecture, in accordance with some embodiments.

FIG. 2 illustrates an exemplary autonomous vehicle 200, in accordance with some embodiments.

FIG. 3 illustrates a functional block diagram for operations of a vehicle (e.g., autonomous vehicle (AV), driver assisted vehicle), in accordance with some embodiments.

FIG. 4 illustrates information flow for a planning solver 400, in accordance with some embodiments.

FIG. 5 illustrates a travel distance (meters) versus time (seconds) plot 500 for different branches and a first set of constraints, in accordance with some embodiments.

FIG. 6 illustrates a travel distance (meters) versus time (seconds) plot 600 for different branches and a second set of constraints, in accordance with some embodiments.

FIG. 7 illustrates a computer-implemented method 700 for deterministic multi-objective constrained optimization for a planning system in a parallelized asynchronous compute architecture, in accordance with some embodiments.

FIG. 8 is a block diagram of a vehicle 1200 having driver assistance, according to some embodiments of the disclosure.

### DETAILED DESCRIPTION OF EMBODIMENTS

Autonomous driving decisions are based on a planning system of an autonomous vehicle (AV). The planning system can accept a proposed and prioritized set of scenarios or goals from a scenario manager, solve the scenarios or goals leveraging the priority, execute the best candidate scenario, report information about the solutions, and produce trajectory plans for a control system, which will generate and send vehicle command signals to the vehicle based on the trajectory plans.

Planning systems evaluate different potential candidate trajectories for the AV and utilize computational resources on potential candidate trajectories with most trajectories not being selected as a best candidate trajectory. This slows the solving of the best candidate trajectory due to evaluating numerous other non-selected candidate trajectories.

Systems and methods for deterministic multi-objective constrained optimization for a planning system in a parallelized asynchronous compute architecture are described herein. An algorithm to solve optimization problems provides deterministic behavior to determine a same candidate trajectory for multi-objective constraints and also culls or terminates a recursive search early when information from other candidate trajectories can be used to determine a sub-optimal candidate trajectory.

In the following description, for purposes of explanation, numerous specific details are set forth in order to provide a thorough understanding of the present disclosure. It will be apparent, however, to one skilled in the art that the present disclosure can be practiced without these specific details. In other instances, well-known structures and devices are shown in block diagram form in order to avoid obscuring the present disclosure.

Reference in the specification to “one embodiment” or “an embodiment” means that a particular feature, structure or characteristic described in connection with the embodiment is included in at least one embodiment of the present disclosure. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

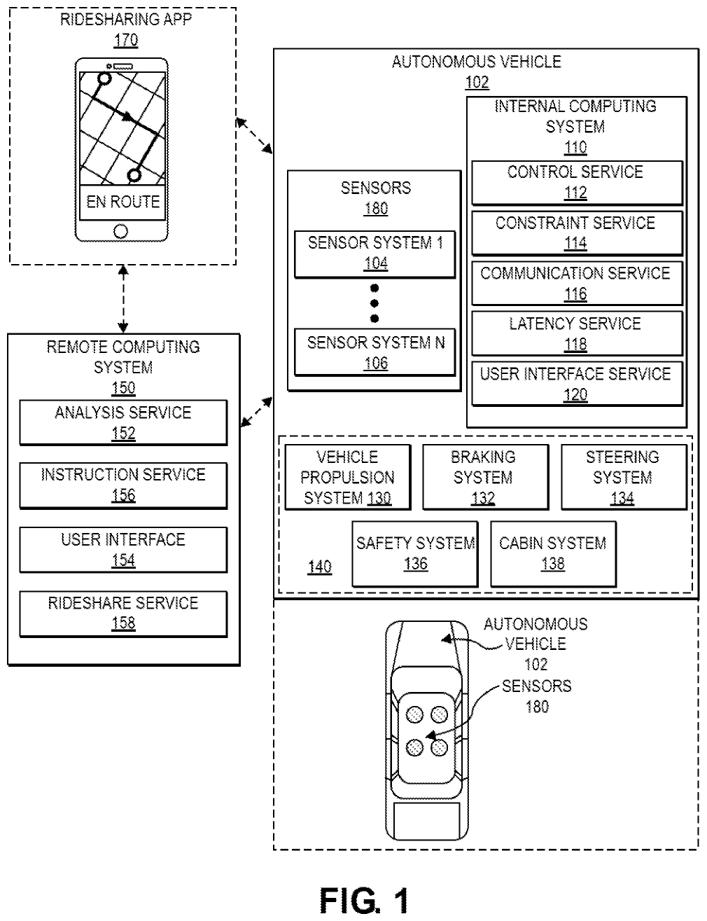

FIG. 1 illustrates an autonomous vehicle and remote computing system architecture in accordance with some embodiments. The autonomous vehicle 102 can navigate about roadways without a human driver based upon sensor signals output by sensor systems 180 of the autonomous vehicle 102. The autonomous vehicle 102 includes a plurality of sensor systems 180 (e.g., a first sensor system 104 through an Nth sensor system 106). The sensor systems 180 are of different types and are arranged about the autonomous vehicle 102. For example, the first sensor system 104 may be a camera sensor system and the Nth sensor system 106 may be a Light Detection and Ranging (LIDAR) sensor system to perform ranging measurements for localization.

The camera sensor system aids in classifying objects and tracking the objects over time. The camera sensor system also supports the identification of free space, among other things. The camera sensor system assists in differentiating various types of motor vehicles, pedestrians, bicycles, and free space. The camera sensor system can identify road objects such as construction cones, barriers, signs, and identify objects such as street signs, streetlights, trees and read dynamic speed limit signs. The camera sensor system can identify stops signs, traffic lights, modified lane boundaries, and modified curbs. The camera sensor system also identifies attributes of other people and objects on the road, such as brake signals from cars, reverse lamps, turn signals, hazard lights, and emergency vehicles, and detect traffic light states and weather.

The LIDAR sensor system supports localization of the vehicle using ground and height reflections in addition to other reflections. The LIDAR sensor system supports locating and identifying static and dynamic objects in space around the vehicle (e.g., bikes, other vehicles, pedestrians), ground debris and road conditions, and detecting headings of moving objects on the road.

Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it should be understood that more or fewer sensors may be coupled to the autonomous vehicle 102.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. In some cases, the braking system 132 may charge a battery of the vehicle through regenerative braking. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 180 and the systems 130, 132, 134, 136, and 138. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 180 and human co-pilots, etc.

The internal computing system 110 can include a control service 112 that is configured to control operation of a mechanical system 140, which includes vehicle propulsion system 130, the braking system 208, the steering system 134, the safety system 136, and the cabin system 138. The control service 112 receives sensor signals from the sensor systems 180 and communicates with other services of the internal computing system 110 to effectuate operation of the autonomous vehicle 102. In some embodiments, control service 112 may carry out operations in concert with one or more other systems of autonomous vehicle 102. The control service 112 can control driving operations of the autonomous vehicle 102 based on sensor signals from the sensor systems 180. In one example, the control service responds to a new or updated trajectory to safely alter a trajectory of the autonomous vehicle to satisfy constraints. The new or update trajectory is selected based on the methods described herein.

The internal computing system 110 can also include a constraint service 114 to facilitate safe propulsion of the autonomous vehicle 102. The constraint service 114 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions, etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate algorithms for operating the autonomous vehicle 102 such as performing methods disclosed herein. The analysis service 152 can also perform analysis pertaining to data associated with one or more errors or constraints reported by autonomous vehicle 102. In another example, the analysis service 152 is located within the internal computing system 110.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle 102 go around an obstacle, change routes, honk the horn, etc.

The rideshare service 158 as depicted in FIG. 1 illustrates a vehicle 102 as a triangle en route from a start point of a trip to an end point of a trip, both of which are illustrated as circular endpoints of a thick line representing a route traveled by the vehicle. The route may be the path of the vehicle from picking up the passenger to dropping off the passenger (or another passenger in the vehicle), or it may be the path of the vehicle from its current location to picking up another passenger.

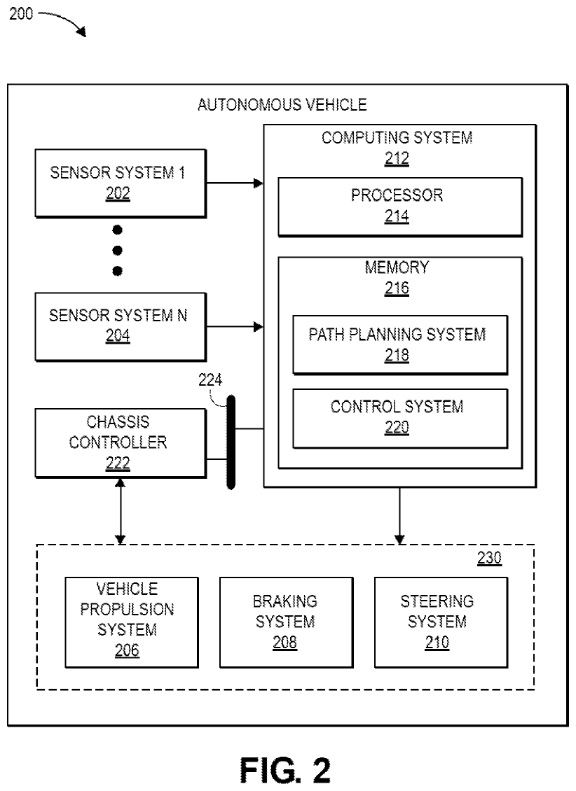

FIG. 2 illustrates an exemplary autonomous vehicle 200 in accordance with some embodiments. The autonomous vehicle 200 can navigate about roadways without a human driver based upon sensor signals output by sensor systems 202-204 of the autonomous vehicle 200. The autonomous vehicle 200 includes a plurality of sensor systems 202-204 (a first sensor system 202 through an Nth sensor system 204). The sensor systems 202-204 are of different types and are arranged about the autonomous vehicle 200. For example, the first sensor system 202 may be a camera sensor system and the Nth sensor system 204 may be a lidar sensor system. Other exemplary sensor systems include, but are not limited to, radar sensor systems, global positioning system (GPS) sensor systems, inertial measurement units (IMU), infrared sensor systems, laser sensor systems, sonar sensor systems, and the like. Furthermore, some or all of the of sensor systems 202-204 may be articulating sensors that can be oriented/rotated such that a field of view of the articulating sensors is directed towards different regions surrounding the autonomous vehicle 200.

A detector of the sensor system provides perception by receiving raw sensor input and using it to determine what is happening around the vehicle. Perception deals with a variety of sensors, including LiDAR, radars, and cameras. The perception functionality provides raw sensor detection and sensor fusion for tracking and prediction of different objects around the vehicle.

The autonomous vehicle 200 further includes several mechanical systems that can be used to effectuate appropriate motion of the autonomous vehicle 200. For instance, the mechanical systems 230 can include but are not limited to, a vehicle propulsion system 206, a braking system 208, and a steering system 210. The vehicle propulsion system 206 may include an electric motor, an internal combustion engine, or both. The braking system 208 can include an engine break, brake pads, actuators, and/or any other suitable componentry that is configured to assist in decelerating the autonomous vehicle 200. The steering system 210 includes suitable componentry that is configured to control the direction of movement of the autonomous vehicle 200 during propulsion.

The autonomous vehicle 200 additionally includes a chassis controller 222 that is activated to manipulate the mechanical systems 206-210 when an activation threshold of the chassis controller 222 is reached.

The autonomous vehicle 200 further comprises a computing system 212 that is in communication with the sensor systems 202-204, the mechanical systems 206-210, and the chassis controller 222. While the chassis controller 222 is activated independently from operations of the computing system 212, the chassis controller 222 may be configured to communicate with the computing system 212, for example, via a controller area network (CAN) bus 224. The computing system 212 includes a processor 214 and memory 216 that stores instructions which are executed by the processor 214 to cause the processor 214 to perform acts in accordance with the instructions.

The memory 216 comprises a path planning system 218 and a control system 220. The path planning system 218 generates a path plan for the autonomous vehicle 200. The path plan can be identified both spatially and temporally according to one or more impending timesteps. The path plan can include one or more maneuvers to be performed by the autonomous vehicle 200. The path planning system 218 may implement operations for planning/execution layer 340, planning solver 400, or method 700 for deterministic selection in a parallelized asynchronous multi-objective optimizer for planning trajectory of an autonomous vehicle.

The control system 220 is configured to control the mechanical systems of the autonomous vehicle 200 (e.g., the vehicle propulsion system 206, the brake system 208, and the steering system 210) based upon an output from the sensor systems 202-204 and/or the path planning system 218. For instance, the mechanical systems can be controlled by the control system 220 to execute the path plan determined by the path planning system 218. Additionally, or alternatively, the control system 220 may control the mechanical systems 206-210 to navigate the autonomous vehicle 200 in accordance with outputs received from the sensor systems 202-204. The control system 220 can control driving operations of the autonomous vehicle 200 based on receiving vehicle commands from the planning system 218.

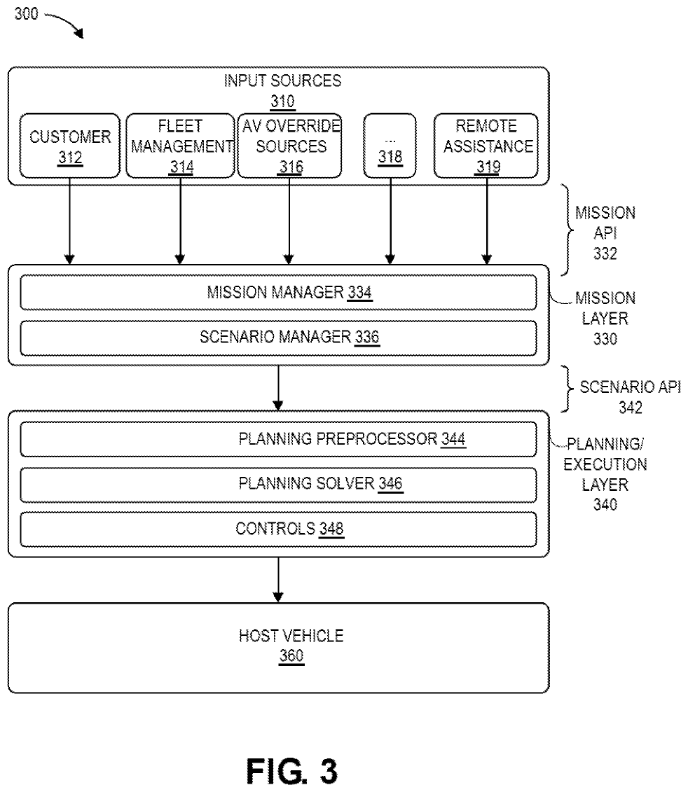

FIG. 3 illustrates a functional block diagram 300 for operations of a vehicle (e.g., autonomous vehicle (AV), driver assisted vehicle), in accordance with some embodiments. The diagram 300 includes input sources 310, a mission layer 330, a planning/execution layer 340 and a host vehicle 360. The input sources 310 can include customer 312 to send an input address to the mission layer 330, a fleet management source 314 to send an instruction (e.g., return to base station and charge the AV) to the mission layer 330, AV override sources 316 (e.g., map change detector, emergency vehicle detector, end trip request, collision detector), other sources 318, and remote assistance 319 to send a request to the mission layer 330. Remote assistance 319 provides support to the AV for safely resuming a planned path upon completing the stop. A remote assistance service instructs the AV when the AV can safely resume driving from the stopped position and return to the planned path and/or provide guidance for altering the original planned path. It is expected that the AV will respond to a listed map change and at the same time initiate a remote assistance session and coming to a safe and (when possible) comfortable stop. The remote assistance service enables control of the AV by a remote human advisor. The remote human advisor can assist for more complex driving situations (e.g., fog, a parade, etc.) while the AV's sensors and control execute the maneuvers.

The mission API 332 provides an API between input sources 310 and the mission layer 330. At the mission level, the requests will be high level and express the intent, without explicit knowledge of specific implementation details (e.g., vehicle commands). Every input source 310 will request one or more missions using the same, unified API. Missions express the intent at the semantic level (i.e., “Drive to A”). The amount of information contained in a request can be minimal or even incomplete (e.g., “Stop now”: without specifying additional constraints); the responsibility of the mission layer is to collect the requests from the different input sources and deconflict them using the current state and context.

Context and additional constraints (e.g., Pull over in one of these 3 spots) provided by a request can be sent independently from the intent with the main rationale being that some input source 310 may not have enough context to communicate the best possible intent. The mission layer 330 has a more complete understanding of the context, and can decide the best action.

At any point in time more than one mission request can be sent from the different input sources 310, and it is the mission layer's 330 responsibility to select the mission to execute as a function of priority for the mission requests and current state of the AV.

At the scenario manager 336, the missions will be translated into a more geometric and quantitative description of the sequence of actions that are sent to the planning/execution layer 340. These requests will be passed to the planning/execution layer 340 using a common and unified scenario API 342, that every planner will implement and execute according to their specific capabilities.

Scenarios are tactical and mapped to the underlying vehicle capabilities, and the scenario API will reflect that. A scenario contains constraints on the end state of the scenario, reference waypoints, and additional information like urgency, etc. Specifying this component allows the mission manager 334 to specify detailed stopping scenarios. The scenario manager 336 handles normal driving, consolidating the high-level decisions communicated by the mission manager 334 and the current driving and environment context into a continuously updated scenario that is then communicated to the planning layer 340 using the scenario API 342. The scenario manager 336 uses a routing engine to lead the vehicle towards a global goal by defining intermediate goals (e.g., turn left, turn right, stop at stop light) that correspond to goals in the local horizon that make progress towards the final destination.

The scenario manager 336 packages these goals in the local horizon with global route costs to give the downstream planner enough context to make decisions around impatience of a rider or passenger and trade-offs with global trip cost. The scenario manager 336 processes goal and scenario override interrupts (e.g., map change detection, immediate pullover button, cabin tampering, remote assistance). When a global goal is nearby, the scenario manager 336 directly sends this goal to the downstream planning layer 340. Scenarios are created in the mission layer 330, and sent to the planning/execution layer 340 as an ordered list of scenarios. Scenarios are tactical and mapped to the underlying vehicle capabilities, and the scenario API will reflect the underlying vehicle capabilities. A scenario contains constraints on the end state of the scenario, reference waypoints, and additional information like urgency, etc.

In one example, the planning/execution layer 340 includes a planning preprocessor 344, a planning solver 346, and controls 348. The planning preprocessor 344 handles details of driving that are not handled by the planning solver 346 and any intermediate scene preprocessing as needed. Examples include exact pullover location selection, EMV response, etc. Some or most of the logic in the planning preprocessor 344 can be transferred to the solver 346. The planning/execution layer 340 will accept a proposed and prioritized set of scenarios or goals from the scenario manager 336, solve the scenarios or goals leveraging the priority, execute the best optimal candidate scenario based on cost functions, report information about the solutions to the mission layer 330, and produce trajectory plans for the controls 348, which will generate and send vehicle command signals to the host vehicle 360 based on the trajectory plans.

In some embodiments, there could be more than one planner (e.g., nominal planning stack and fallback planning stack), and each planner can internally use several different algorithms and solvers, but the planners will all use a common scenario API 342. A nominal planning stack implements a full set of capabilities of the AV while the fallback planning stack may handle a limited set of capabilities, like stopping and relocation. The fallback planning stack controls the planning of the AV when the nominal planning stack is not operational (e.g., hardware or software fault, severely degraded states, etc.). After the planning layer finishes solving, the planning layer shares whether each scenario was satisfied and the mission manager uses this information to track progress towards scenario completion and manage a current portfolio of active scenarios.

The result of the requests is communicated back to the mission layer 330, which can then propagate it back to the customer (Remote Operator for example) or reuse it to re-prioritize subsequent scenarios. The planning layer will not need to wait for the mission manager to select the best scenario to be executed, and only needs to report the relevant information at every clock tick. That information contains, among other pieces of information, which scenarios have been explored, success/failure flags, the active scenario and its progress.

The planning solver can be a coupled solver that simultaneously solves laterally and longitudinally, and resolves a long tail of highly dynamic scenarios in a systematic manner for an AV. The planning solver operates in coupled, longitudinal and lateral, space such that lateral decisions affect longitudinal behavior and vice versa. The planning solver utilizes a semantic world representation to explore a search space more efficiently. The planning solver opportunistically explores the search space using semantic branching in order to only consider objects that are relevant to the AV intent. Instead of blindly probing for solutions, the planning solver relies on a fast trajectory proposal generator to find trajectories around objects that satisfy constraints (e.g., stop the vehicle, limit the maximum speed to 10 mph). Solvers are maneuver agnostic and rely on the modulation of inputs to get maneuver specificity. Tactics are maneuver specific and provide inputs for solvers in a graph-like space (e.g., options to go in front, behind, to the left or right of objects in a kinematically reachable set of the AV). Priority and trajectory evaluation is performed in the semantic graph module, which is a data structure and collection of related methods or operations that are used to conduct a semantic search and organize data necessary for the semantic search, as well as provide technical support with access to debug information. Branching suggestions and cost evaluation are computed in individual tactics (e.g., cost modules). The trajectory proposal generator resolves semantic constraints into proposed candidate trajectories.

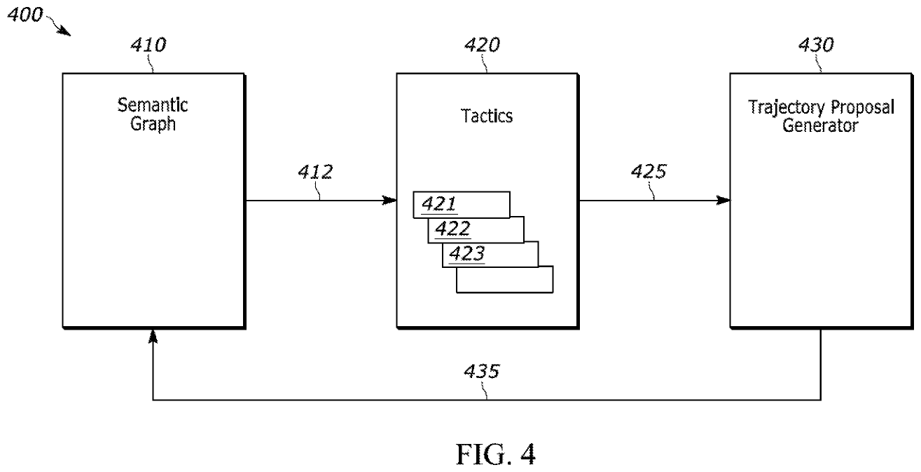

FIG. 4 illustrates information flow for a planning solver 400 in accordance with one embodiment. A semantic graph 410, tactics 420, and trajectory proposal generator share information via communications 412, 425, and 435. A semantic graph 410 starts with a few seed candidate trajectories. Trajectories are evaluated by using tactics that provide a general purpose interface for modular capabilities. Each tactic will encode functionality that is related to a particular ordinal cost or cost function the tactic is implementing as a cost element (e.g., collision 421, stop point 423, commit region 422, etc.). Tactics will allow the planning solver to efficiently combine various capabilities to produce solutions that use these capabilities when appropriate. This will allow for easy expansion of functionality and encapsulation of business knowledge in individual modules. Tactics 420 suggest new branches and compute constraints based on cost seams. A trajectory proposal generator 430 (TPG) computes new candidate trajectories based on new constraints. The TPG 430 computes coupled trajectories using numerical optimization techniques. New candidate trajectories get evaluated by the semantic graph 410, which also prioritizes candidate trajectories and their branches. The semantic graph 410 also requests new branches to be evaluated based on seam detections from tactics. A seam detection is a violation of a cost threshold. From the software organization perspective, the semantic graph manages and invokes tactics 420 and TPG 430. A semantic search refers to a searching system that does not require exact matches, but rather retrieves examples that are similar in meaning or useful to an ideal query result. An AV motion planning semantic refers to concepts and representations of the world being delineated in relation to and for the purpose of controlling the AV.

In the semantic search, nodes and branch splits are created on need basis, when cost field thresholds are violated. A semantic branching search strategy is opportunistic in nature. The semantic branching strategy is a specific version of the semantic search that leverages the semantics to discover new candidate trajectories from the evaluation of candidate trajectories with the new candidate trajectories being semantically superior to prior non-optimal candidate trajectories. The semantic branching search strategy follows a default comfortable trajectory (or a set of default comfortable trajectories that could include the previous tick, safe stop, following a nominal trajectory, etc.) and reacts to objects that directly interfere with that trajectory. By being opportunistic, the planner solver avoids objects that are directly in the desired way and closer in predicted time.

In one example of a semantic search strategy, each trajectory is evaluated at certain time increments (e.g., 0.5 second increments) and existing ordinal costs are computed at each step. When a new cost threshold is violated, tactics (e.g., cost modules) will present a new set of constraints that will avoid that cost. At this point, an option is provided to continue exploring the existing candidate trajectory or propose a new candidate trajectory. Each branch is defined by a set of constraints. By default, these are set to allow simple driving. By adding constraints, the branch gains complexity and semantic meaning. The TPG 430 will utilize the newly detected constraint(s) along with the existing constraints from the parent branch and suggest a new candidate trajectory. Each trajectory is a coupled (e.g., x, y, time) trajectory that meets the provided constraints or at least gets as close as possible to the provided constraints.

The planning solver performs a deterministic multi-objective constrained optimization in a parallelized asynchronous compute architecture. One challenge of a planning solver is reducing a size of a tree structure of candidate trajectories to fewer candidate trajectories that are computationally tractable yet still able to provide viable candidate trajectories in real time during driving of the AV. The tree structure is part of the semantic graph that describes the lineage such as parent or child of discovery of semantic branches. A branch is a construct in the semantic branching search strategy, and within the set of information comprising a branch is a temporal sequence of kinematic states that can be referred to as a trajectory, or a sparse representation of information necessary to create a semantically similar motion plan.

In one embodiment, culling of the tree of candidate trajectories is performed to reduce the number of candidate trajectories being evaluated. Culling will stop the exploration (or evaluation) of a particular branch of the planning solver if a lower cost alternative already exists. A lower cost alternative, in the context of the planning solver means a branch that has been explored all the way up to the planning horizon and has a lower cost. Culling refers to a specific implementation or logic for the general concepts of bounding or termination of recursion.

Culling exploits the following properties of the planning solver:
(1) All costs of the planning solver are monotonically increasing during a planning horizon.
(2) The planning solver, at all times, maintains a record of all branches that have been explored in a data structure.
(3) The data structure stores the costs of the last node of each and every branch that is explored all the way up to the time horizon.

When a branch of the planning solver is being explored, each node of said branch is evaluated against nodes stored in the data structure. If the cost of this node being explored is greater than nodes in the data structure, then the branch is culled as there is no way for this branch to ever have a lower cost. The planning solver can select one branch as its candidate trajectory solution.

Simulations of different scenarios indicate that culling significantly improves runtime performance of the planning solver.

The planning solver is multi-threaded. This basically means that branches can be explored in any order. This multi-threaded property also means that the data structure can be updated in any order. In other words, for any branch that is not the solution branch having a selected candidate trajectory, whether or not a branch is allowed to be evaluated to the end of the planning time horizon is dictated by the order in which the branch is explored.

In one example, if the planning solver evaluates 3 branches in order of increasing cost, there is a chance that only a solution branch will be evaluated till a termination of this solving process to select an optimal candidate trajectory for the planning system. However, if the order is reversed, all 3 branches will be explored until the termination of this solving process.

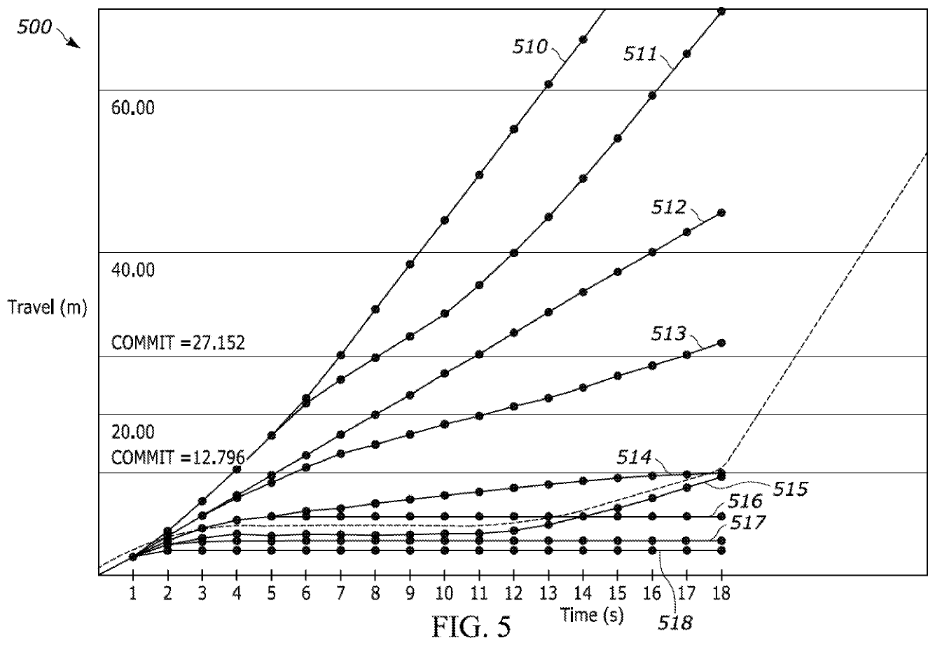

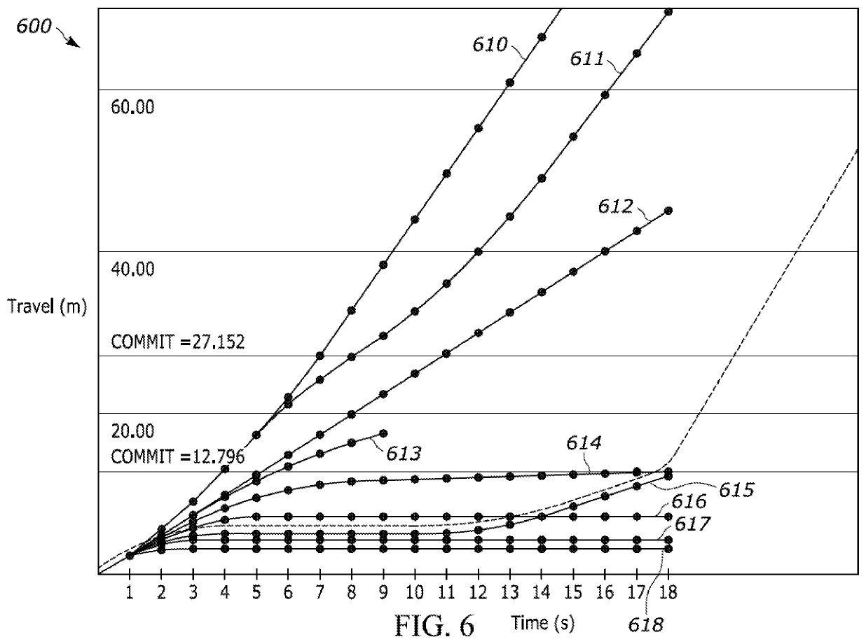

Furthermore, this randomness in evaluation not only affects a length of the branch that is being evaluated, but also the nature of the children that are generated. This can be explained by looking at the solutions of FIGS. 5 and 6, the inputs for which are the exact same.

FIG. 5 illustrates a travel distance (meters) versus time (seconds) plot 500 for different branches 510-518 and a first set of constraints in accordance with one embodiment. A first solve generates the first set of constraints, including a time to collision yield constraint to indicate a time until a collision occurs if AV moves a little slower or faster, a mitigated risk of collision AV moving yield constraint to indicate that a collision severity is based on penetration between AV and nearby vehicle while the AV is in motion, a risk of the future replanning yield constraint to encourage planning solver to prefer paths that do not rely on replanning to avoid a collision, an induced discomfort yield constraint to indicate induced discomfort for a passenger due to deceleration, and a front obstacle buffer violation severity yield constraint to indicate uncertainty of longitudinal prediction for an obstacle and the position of the AV.

FIG. 6 illustrates a travel distance (meters) versus time (seconds) plot 600 for different branches 610-618 and a second set of constraints in accordance with one embodiment. The second set of constraints include a time to collision yield constraint, a mitigated risk of collision AV moving yield constraint, an induced discomfort yield constraint, a time to collision yield constraint, and a front obstacle buffer violation severity yield constraint. In some embodiments, a second solve does not generate a risk of the future replanning yield constraint.

While both solutions look the same in FIGS. 5 and 6, the first solve in FIG. 5 has a solution 515 that was created as a result of six constraints while the second solve in FIG. 6 has a solution 615 that was created as a result of five constraints. This difference in constraints occurs because the second solve has one branch that is not explored all the way to the termination of the solve process. A solution ancestor of the second solve is explored only till time step 10 because of culling, while a solution ancestor of the first solve is explored all the way to timestep 18. At time step 10, neither ancestor generates risk of a future replan constraint. At time step 12, solution ancestor of the first solve does generate the risk of future replan constraint. However, since the solution ancestor of the second solve was culled at time step 10, the second solve does not generate the risk of future replan constraint.

The planning solver when creating a child branch, groups all similar constraint types for the same agent. An agent can be an obstacle, object, vehicle, etc. In other words, all child yield constraints for the same agent are grouped together and combined with the constraints of the parent branch (if any) to create one child branch, all child assert constraints of the same agent are grouped together and combined with the constraints of the parent branch (if any) to create the next child branch and so on so forth. This is done to reduce the number of branches created because of the same agent.

In one example, the AV is following a lead car and a prediction component is highly uncertain about positioning of this lead car. Assume a branch being explored violates the front buffer cost of this lead car at time step 3 and the risk of future replan cost is violated at time step 6 (because the further you go in time, the worse the uncertainty of an object can become). In other words, the planning solver may maintain a distance that is larger than the front buffer to avoid hitting the uncertainty bubble of the lead car. The only way the next branch that gets explored has all costs below a set of thresholds is when this next branch has both front buffer and risk of future replan constraints. There are two possible ways this can be achieved.
(1) First a child branch is generated based on just the front buffer constraint. This branch then encounters the risk of future replan costs, a new child constraint is created, and a branch containing both front buffer and risk of future replan constraints is created, which avoids all costs. Thus, the planning solver creates 2 branches.
(2) The planning solver combines both constraints from the start and creates a single child branch that has both constraints. Thus, the planning solver ends up creating only 1 branch.

However, (2) is not possible if the parent branch gets culled before time step 6 because constraints are generated only when costs violate thresholds, which in turn can happen only when the node that violates the cost is explored.

Before describing how the planning solver can be deterministic with culling, there is one more fact about the exploration of the planning solver to be explained.

In another example, an AV is following vehicle A, which is following vehicle B. Assume a max acceleration branch is being explored by the planning solver, and the AV first hits vehicle A and then hits vehicle B. Even though the max acceleration branch hits both vehicle A and vehicle B, the max acceleration branch only spawns a branch for vehicle A and not vehicle B. Constraints for vehicle B are put in a bucket called later in time constraints because vehicle B is encountered after vehicle A in predictive time. In other words, the max acceleration branch does not have a responsibility to create a child branch for vehicle B, but rather, a child branch has a responsibility to create a child branch for vehicle B, if the child branch encounters vehicle B again. In this example, if a branch is generated that yields to vehicle A, this branch will not encounter vehicle B. However, if a branch is generated that asserts over vehicle A, this branch will encounter vehicle B, and this branch has the responsibility to generate constraints for vehicle B. This makes grouping and generation of child constraints for a parent branch (in this case the max acceleration branch) straightforward.

To summarize, culling can cause non-determinism because constraints are created when nodes violate costs. The number of nodes of a branch that end up getting explored is dictated by costs that the branch encounters and the branches that have been explored and stored in the data structure with candidate trajectories prior to the exploration of this branch.

Due to multi-threading, there is no guarantee about the order of branch exploration. This can cause any parent branch to be culled at any point, which in turn may cause a parent branch to not generate and group certain constraints, which in turn can lead to a solution branch having a different set of constraints, even for the same inputs, leading to non-determinism.

The planning solver of the present disclosure has been designed to include culling and be deterministic. Returning to the example of the AV following a lead car, the planning solver explores a branch A that encounters the front buffer cost at time step 3 and risk of future replan cost at time step 6. For the sake of simplicity, assume that these are the only costs that any branch can encounter. The only time branch A can get culled before branch A reaches time step 6 is if a branch B, which has a lower front buffer cost at timestep 3, was explored before branch A. As a result of this, branch A never encounters the risk of future replan constraints, and its child (assuming branch A becomes the solution) does not have the risk of future replan constraint. This would not have happened had branch A not been culled.

Now what if, regardless of the branch A being culled or not, branch A only creates the child based on the front buffer constraint. In both cases, the child will have only one constraint. If the child violates the risk of future replan cost, the child is free to generate a new child based on the risk of future replan constraint.

In one embodiment, the planning solver will determine when to stop generating child constraints for a particular branch based on a first node of a branch. Since a branch is guaranteed to generate a constraint, and hence a new child branch is generated if there is a cost violation (unless there is a cost constraint mismatch from a future constraint not being generated), the planning solver only generates constraints at the first node of the branch that has any cost violation. The planning solver still groups constraints for the same agent that are generated on the node in question. However, any constraints for costs encountered in the future after the first node are not considered. In other words, any node after the first node that has a cost violation, is not allowed to generate constraints. Any future constraints are an issue of the child branch that gets explored later.

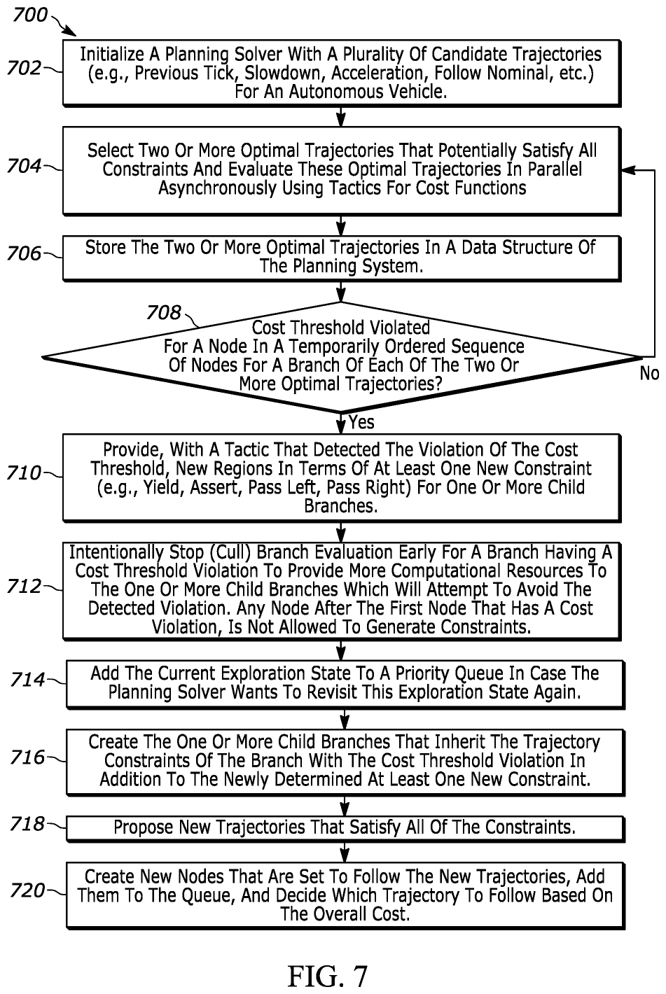

FIG. 7 illustrates a computer-implemented method 700 for deterministic multi-objective constrained optimization for a planning system in a parallelized asynchronous compute architecture in accordance with one embodiment. An algorithm solves optimization problems and provides deterministic behavior to determine a same candidate trajectory for multi-objective constraints and also culls or terminates a recursive search early when information from other candidate trajectories can be used to determine a sub-optimal candidate trajectory.

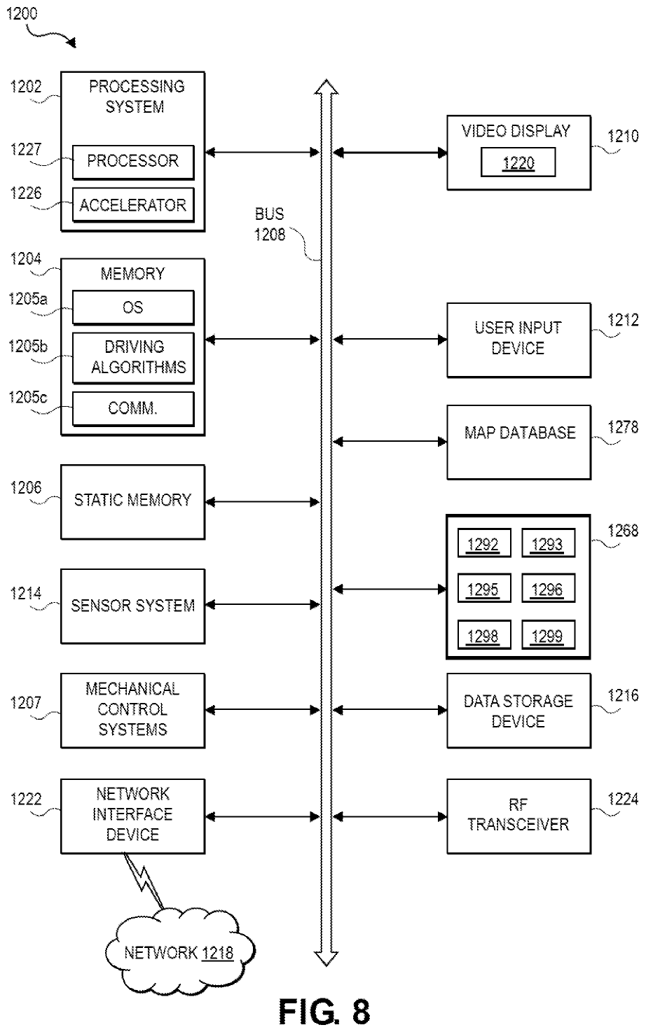

This computer-implemented method 700 can be performed by processing logic of a computing system that may comprise hardware (circuitry, dedicated logic, a processor, etc.), software (e.g., planning software, planning layer, or planning solver run on a general purpose computer system or a dedicated machine or a device), or a combination of both. The method 700 can be performed by an internal computing system 110 or remoting computing system 150 of FIG. 1, the computing system 212 of FIG. 2, or the system 1202 of FIG. 8.

At operation 702, the computer-implemented method initializes a planning solver with a plurality of candidate trajectories (e.g., previous tick, slowdown, acceleration, follow nominal, etc.) for an autonomous vehicle.

Until an optimal trajectory is determined or until time out, at operation 704 the computer-implemented method selects two or more optimal candidate trajectories that potentially satisfy all constraints and evaluates these optimal candidate trajectories in parallel using tactics for cost functions. At operation 706, the two or more optimal candidate trajectories are stored in a data structure of the planning system. If the cost of a node of a branch being explored is greater than nodes stored in the data structure, then the branch can be culled as there is no way for this branch to ever have a lower cost. At operation 708, the computer-implemented method determines a node (e.g., a first node or an initial node) in a temporarily ordered sequence of nodes for which a cost threshold is violated if any for a branch of each of the two or more optimal candidate trajectories. If a cost threshold is violated, then the tactic that detected the violation of the cost threshold (a cost seam) will provide new regions in terms of at least one new constraint (e.g., yield, assert, pass left, pass right) for one or more child branches of the first node at operation 710. If no cost threshold violation occurs, then the method returns to operation 704. The planning solver intentionally stops branch evaluation early for a branch having a cost threshold violation for a non-optimal candidate trajectory at operation 712 to provide more computational resources to child branches which will attempt to avoid the detected violation (cost seam). Any node including a second node after the first node that has a cost violation, is not allowed to generate constraints.

At operation 714, the current exploration state is added to a priority queue in case the planning solver wants to revisit this exploration state again. Sometimes, the selected trajectory needs to go through lower ordinals in order to satisfy higher ordinals.

At operation 716, the computer-implemented method creates one or more new child branches that inherit trajectory constraints of the branch (e.g., parent branch) in addition to the newly determined constraint.

At operation 718, the computer-implemented method proposes new candidate trajectories that satisfy all of the constraints. At operation 720, the computer-implemented method creates new nodes that are set to follow the new candidate trajectories, adds the new candidate trajectories to the queue, and decides which trajectory to follow based on the overall cost.

One can visualize the planning solver to perform a binary search (e.g., recursive search) through space. The planning solver opportunistically starts with the optimal candidate trajectories of a desired outcome, and divides the space as the planning solver explores the space further and detects new cost fields along the way. Some costs are known up front, but the costs associated with interactive objects are not. As such, the algorithm for method 700 is designed to handle worst-case cost fields that are unknown ahead of time, and becomes more efficient if the worst-case cost fields are known ahead of time.

The planning solver is designed with overlapping parent branch and child branch exploration to prevent regression of runtime performance.

In an example, a child branch can be explored once the exploration of the parent branch is complete. In other words, child exploration begins at either:
(1) time step==18 (e.g., t planning horizon), after the parent branch has been explored all the way to the planning horizon, or
(2) time step at which parent branch is culled (e.g., t culling).

In one embodiment of the present disclosure, the planning solver is prevented from generating constraints at any time step (e.g., t violation) beyond a timestep of a first or initial cost violation of the parent branch. Hence, all constraints required to generate the child branch are generated at t violation. This fact is leveraged in combination with starting the exploration of the child branch, in parallel with the evaluation of the parent branch, instead of waiting for the parent branch to reach t planning horizon. Note, t violation equals t culling in those cases where a branch gets culled. This overlapping of parent and child exploration for the planning solver helps to mitigate the performance impact, and in some cases, improves runtime performance of the planning solver. Simulations show that runtime performance improves when deterministic culling is enabled compared to non-deterministic culling being enabled.

In the proposed planning solver, graph search which is traditionally hard to parallelize will work on a higher level and will be only a few layers deep. Therefore, the overhead of running the graph search will be low. Most of the work will be done in generating new trajectories based on constraints provided by the semantic graph, and tactic evaluation. This makes the algorithm of the planning solver easy to parallelize on per trajectory level. Since the planning solver cannot guarantee to explore all of the branches needed to find the optimal solution in a worst case scenario, the planning solver has work balancing functionality. Work balancing functionality will have two roles: to ensure determinism independent from the number of available threads, and to terminate additional branching to ensure some solution is produced even if not optimal.

Technically, the only source of nondeterminism in this planning solver will be the case when time expires to explore all of the branches. This can be avoided by introducing a synchronization step at each level of the graph search. Synchronization step, by definition, will reduce thread utilization. To alleviate the utilization issue, based on the total number of branches that can be explored, hybrid approaches are implemented that trade off worst case timing stability for thread utilization. For example, one strategy would be to introduce a synchronization step at every other graph level. That would allow more branches to be evaluated in parallel, hence higher utilization, however this strategy causes evaluating more nodes at once and that might add to the overall worst case timing. In addition, to save on computational effort, the planning solver can implement checks that prevent exploring trajectories that are already costlier than the best trajectory found so far. To maintain determinism, the best trajectory cost (or any other global check) will need to be computed at the synchronization step.

By branching when a violation of a cost threshold is detected (e.g., at operation 708), the planning solver intentionally stops branch evaluation early to provide more computational resources to child branches which will attempt to avoid that violation (cost seam). In difficult scenarios, the planning solver might keep branching until running out of time in the tick period and never reach the goal region. Therefore, the planning system includes logic that monitors the time spent in the search and once it is determined that the algorithm is out of time for the cycle, the most promising few candidate trajectories will be evaluated to completion and the most favorable candidate trajectory based on the overall trajectory cost will be selected as a solution.

FIG. 8 is a block diagram of a vehicle 1200 having driver assistance according to an embodiment of the disclosure. The driver assistance features of the vehicle 1200 can include one or more of adaptive cruise control, collision avoidance systems, connecting smartphones for hands-free dialing, automatic braking, satellite navigation, traffic warnings, etc.). Within the processing system 1202 (or computer system 1202) is a set of instructions (one or more software programs) for causing the machine to perform any one or more of the methodologies discussed herein including method 700. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The processing system 1202, as disclosed above, includes processing logic in the form of a general purpose instruction-based processor 1227 or an accelerator 1226 (e.g., graphics processing units (GPUs), FPGA, ASIC, etc.)). The general purpose instruction-based processor may be one or more general purpose instruction-based processors or processing devices (e.g., microprocessor, central processing unit, or the like). More particularly, processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Processing system 1202 is configured to perform the operations and methods discussed herein. The exemplary vehicle 1200 includes a processing system 1202, main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable non-transitory computer-readable storage medium), which communicate with each other via a bus 1208. The storage units disclosed herein may be configured to implement the data storing mechanisms for performing the operations and methods discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1202. Furthermore, memory 1206 may store additional modules and data structures not described above.

The vehicle 1200 includes a map database 1278 that downloads and stores map information for different and various locations, where the map database 1278 is in communication with the bus 1208.

The processor 1268 would include a number of algorithms and sub-systems for providing perception and coordination features including perception input 1296, central sensor fusion 1298, external object state 1295, host state 1292, situation awareness 1293 and localization and maps 1299.

Operating system 1205a includes various procedures, sets of instructions, software components and/or drivers for controlling and managing general system tasks and facilitates communication between various hardware and software components. Driving algorithms 1205b (e.g., object detection, segmentation, path planning, method 700, etc.) utilize sensor data from the sensor system 1214 to provide object detection, segmentation, deterministic selection in a parallelized asynchronous multi-objective optimizer for planning trajectory of a vehicle, and driver assistance features for different applications such as driving operations of vehicles. A communication module 1205c provides communication with other devices utilizing the network interface device 1222 or RF transceiver 1224.

The vehicle 1200 may further include a network interface device 1222. In an alternative embodiment, the data processing system disclosed is integrated into the network interface device 1222 as disclosed herein. The vehicle 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), and a Graphic User Interface (GUI) 1220 (e.g., a touch-screen with input & output functionality) that is provided by the video display unit 1210.

The vehicle 1200 may further include a RF transceiver 1224 that provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The data storage device 1216 may include a machine-readable storage medium (or more specifically a non-transitory computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202, the main memory 1204 and the data processing system 1202 also constituting machine-readable storage media.

In one example, the vehicle 1200 with driver assistance is an autonomous vehicle that may be connected (e.g., networked) to other machines or other autonomous vehicles using a network 1218 (e.g., LAN, WAN, cellular network, or any network). The vehicle can be a distributed system that includes many computers networked within the vehicle. The vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The vehicle can operate in the capacity of a server or a client in a client-server network environment, or as a peer machine in a peer-to-peer (or distributed) network environment. The storage units disclosed in vehicle 1200 may be configured to implement data storing mechanisms for performing the operations of autonomous vehicles.

The vehicle 1200 also includes sensor system 1214 and mechanical control systems 1207 (e.g., chassis control, vehicle propulsion system, driving wheel control, brake control, etc.). The system 1202 executes software instructions to perform different features and functionality (e.g., driving decisions, deterministic selection in a parallelized asynchronous multi-objective optimizer for planning trajectory) and provide a graphical user interface 1220 for an occupant of the vehicle. The system 1202 performs the different features and functionality for autonomous operation of the vehicle based at least partially on receiving input from the sensor system 1214 that includes lidar sensors, cameras, radar, GPS, and additional sensors. The system 1202 may be an electronic control unit for the vehicle.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

1. A computer implemented method for deterministic multi-objective constrained optimization for a planning system of an autonomous vehicle (AV), the computer implemented method comprising:
initializing a planning solver with a plurality of candidate trajectories for the AV;
selecting two or more optimal candidate trajectories that potentially satisfy a set of constraints and evaluating these two or more optimal candidate trajectories in parallel asynchronously using cost functions;
determining a node in a temporarily ordered sequence of nodes for which a cost threshold is violated if any for a branch of each of the two or more optimal candidate trajectories; and
intentionally stopping branch evaluation early for a branch having a cost threshold violation.

2. The computer implemented method of claim 1, further comprising:
providing a child branch with a new constraint in response to the branch having a cost threshold violation.

3. The computer implemented method of claim 2, wherein the child branch inherits trajectory constraints of the branch in addition to the new constraint.

4. The computer implemented method of claim 1, wherein the new constraint comprises a yield, an assert, a pass left, or a pass right constraint.

5. The computer implemented method of claim 1, wherein the planning solver intentionally stops branch evaluation early for the branch having the cost threshold violation for a non-optimal candidate trajectory to provide more computational resources to a child branch that will attempt to avoid the cost threshold violation.

6. The computer implemented method of claim 1, wherein any node, after the node of the branch that has a cost threshold violation, is not allowed to generate constraints.

7. The computer implemented method of claim 1, further comprises:
proposing new trajectories to satisfy the set of constraints; and
creating new nodes to follow the new trajectories.

8. The computer implemented method of claim 1, wherein the planning solver comprises an algorithm to provide a multi-objective constrained optimization with deterministic behavior to determine a same candidate trajectory for multi-objective constraints in a parallelized asynchronous compute architecture.

9. A computing system, comprising:
a memory storing instructions; and
a processor coupled to the memory, the processor is configured to execute instructions of a software program to:
initialize a plurality of candidate trajectories for an autonomous vehicle, select two or more optimal candidate trajectories that potentially satisfy all constraints and evaluate these two or more optimal candidate trajectories in parallel asynchronously using cost functions, determine a node in a temporarily ordered sequence of nodes for which a cost threshold is violated if any for a branch of each of the two or more optimal candidate trajectories, and intentionally stop branch evaluation early for a branch having a cost threshold violation.

10. The computing system of claim 9, wherein the processor is configured to execute instructions of the software program to:
provide a child branch with a new constraint in response to the branch having a cost threshold violation.

11. The computing system of claim 10, wherein the child branch inherits trajectory constraints of the branch in addition to the new constraint, wherein the new constraint comprises a yield, an assert, a pass left, or a pass right constraint.

12. The computing system of claim 9, wherein any node, after the node of the branch that has a cost threshold violation, is not allowed to generate constraints.

13. A non-transitory computer readable storage medium having embodied thereon a program, wherein the program is executable by a processor to perform a method comprising:
initializing a planning solver with a plurality of candidate trajectories for an autonomous vehicle;
selecting two or more optimal candidate trajectories that potentially satisfy all constraints and evaluating these two or more optimal candidate trajectories in parallel asynchronously using cost functions;
determining a node in a temporarily ordered sequence of nodes for which a cost threshold is violated if any for a branch of each of the two or more optimal candidate trajectories; and
intentionally stopping branch evaluation early for a branch having a cost threshold violation.

14. The non-transitory computer readable storage medium of claim 13, the method further comprising:
providing a child branch with a new constraint in response to the branch having a cost threshold violation.

15. The non-transitory computer readable storage medium of claim 14, wherein the child branch inherits trajectory constraints of the branch in addition to the new constraint.

16. The non-transitory computer readable storage medium of claim 15, wherein the new constraint comprises a yield, an assert, a pass left, or a pass right constraint.

17. The non-transitory computer readable storage medium of claim 13, wherein the planning solver intentionally stops branch evaluation early for the branch having the cost threshold violation to provide more computational resources to a child branch that will attempt to avoid the cost threshold violation.

18. The non-transitory computer readable storage medium of claim 13, wherein any node, after the node of the branch that has a cost threshold violation, is not allowed to generate constraints.

19. The non-transitory computer readable storage medium of claim 13, the method further comprises:
proposing new trajectories to satisfy all of the constraints; and
creating new nodes to follow the new trajectories.

20. The non-transitory computer readable storage medium of claim 13, wherein the planning solver comprises an algorithm to provide a multi-objective constrained optimization with deterministic behavior to determine a same candidate trajectory for multi-objective constraints in a parallelized asynchronous compute architecture.
